(19) United States
(12) Patent Application Publication
(10) Pub. No.: US 2013/0076125 A1
(43) Pub. Date: Mar. 28, 2013

(54) LOAD CONTROL DEVICE

(71) Applicant: Takashi Aragai, Aichi (JP)

(72) Inventor: Takashi Aragai, Aichi (JP)

(73) Assignee: OMRON AUTOMOTIVE ELECTRONICS CO., LTD., Aichi (JP)

(21) Appl. No.: 13/619,371

(22) Filed: Sep. 14, 2012

(30) Foreign Application Priority Data
Sep. 28, 2011 (JP) 2011-212767

(51) Int. Cl. B60L 1/00

(52) U.S. Cl. 307/9.1

(57) ABSTRACT

A load control device controls a load of a vehicle based on a signal inputted from a manipulation part manipulated by a user. The load control device includes a first command part that issues a first command to supply an electric power to the load based on the signal from the manipulation part, and outputs a predetermined operating signal when operating normally, a second command part that issues a second command to supply the electric power to the load when the operating signal is not inputted from the first command part, and an electric-power supply controller that controls the supply of the electric power to the load based on the first command or the second command.

### TECHNICAL FIELD

The present invention relates to a load control device and, particularly to a load control device that controls a load of a vehicle.

### RELATED ART

Conventionally, there is proposed a technology of being able to light a headlight even if a communication failure is generated between a manipulation switch of the headlight and a control device that controls the headlight.

For example, in a proposal of Japanese Unexamined Patent Publication No. 7-232603, a transmission-side ECU (Electronic Control Unit) including a headlight switch and a headlight ECU are connected to each other by a communication bus and a power source supply line. When the headlight switch is turned on, communication data of an on state of the headlight is supplied from the transmission-side ECU to the headlight ECU through the communication bus, and an analog signal of the on state of the headlight is supplied from the transmission-side ECU to the headlight ECU through the power source supply line. Therefore, even if the communication bus is disconnected, the headlight can be lit using the analog signal passed through the power source supply line.

In addition, conventionally, there is also proposed an in-vehicle system as shown in FIG. 1.

Specifically, the in-vehicle system in FIG. 1 includes a combination SW (switch) 11, a BCM (Body Control Module) 12, and a headlight 13. The combination SW 11 includes a headlight SW 21 and a CPU 22. The BCM 12 includes a CPU 31, a high-side driver 32, and a transistor TR. The combination SW 11 and the BCM 12 are connected to each other through a communication line 14 and a signal line 15.

When the headlight SW 21 of the combination SW 11 is turned on, the CPU 22 detects the turn-on of the headlight SW 21, and starts the output of a headlight turn-on signal to the CPU 31 of the BCM 12 through the communication line 14. The CPU 31 that receives the headlight turn-on signal outputs a command signal of a positive logic (high active) to the high-side driver 32 in order to cause the high-side driver 32 to light the headlight 13. In response to the input of the command signal, the high-side driver 32 starts the supply of an electric power from a battery power source+B to the headlight 13 to light the headlight 13.

When the headlight SW 21 is turned on, a potential at a base of the transistor TR becomes a low level (ground level) to turn on the transistor TR. While the ignition power source is turned on, the electric power is inputted from the ignition power source IG to the high-side driver 32 through the transistor TR. Therefore, the input voltage of the high-side driver 32 becomes a high level, and the high-side driver 32 becomes the state similar to the state in which the command signal is inputted.

Accordingly, as illustrated in FIG. 2, the headlight 13 can be lit by turning on the ignition power source IG and the headlight SW 21, even if the CPU 31 cannot detect the state of the headlight SW 21 because a failure is generated in the communication line 14 to generate the communication failure between the CPU 22 and the CPU 31.

However, in the proposal of Japanese Unexamined Patent Publication No. 7-232603 and the in-vehicle system in FIG. 1, the number of wiring systems between the transmission-side ECU and the headlight ECU increases by one, and the number of wiring systems between the combination SW 11 and the BCM 12 increases by one. Therefore, it is necessary to add a harness and a connector pin for the increased wiring system, which results in a cost increase and a weight gain of the vehicle.

In the proposal of Japanese Unexamined Patent Publication No. 7-232603 and the in-vehicle system in FIG. 1, the headlight cannot be lit when abnormalities, such as a disconnection, a power-source short circuit, and a ground fault, are simultaneously generated in the two wiring systems.

In the proposal of Japanese Unexamined Patent Publication No. 7-232603, the headlight cannot be lit when the abnormality is generated in the headlight ECU though the abnormality is not generated in the wiring system.

### SUMMARY

The present invention has been devised to solve the problems described above, and an object thereof is to surely operate the load of the vehicle even when the abnormality is generated.

In accordance with one aspect of the present invention, there is provided a load control device that controls a load of a vehicle based on a signal inputted from a manipulation part manipulated by a user, the load control device including: a first command part that issues a first command to supply an electric power to the load based on the signal from the manipulation part, and outputs a predetermined operating signal when operating normally; a second command part that issues a second command to supply the electric power to the load when the operating signal is not inputted from the first command part; and an electric-power supply controller that controls the supply of the electric power to the load based on the first command or the second command.

In the load control device in accordance with the aspect of the present invention, the first command part issues the first command to supply the electric power to the load based on the signal from the manipulation part, and outputs the predetermined operating signal when operating normally, the second command part issues the second command to supply the electric power to the load when the operating signal is not inputted from the first command part, and the supply of the electric power to the load is controlled based on the first command or the second command.

Accordingly, the vehicle load can surely be actuated.

For example, the manipulation part includes manipulation means, such as a switch, a button, and a key. For example, the first command part includes a control circuit, such as a CPU (Central Processing Unit) and an ECU (Electronic Control Unit). For example, the second command part includes a drive retaining and integrating circuit or a drive retaining circuit. For example, the electric-power supply controller includes a driver circuit.

The second command part may issue the second command when the vehicle is in a predetermined supply state of a power source.

Therefore, for example, when the abnormality is generated in the first command part, the on and off states of the load can be controlled in conjunction with the supply state of the power source of the vehicle.

The second command part may issue the second command when the vehicle is in the predetermined supply state of the power source, and when brightness around the vehicle is less than a predetermined threshold.

Therefore, for example, when the abnormality is generated in the first command part, the on and off states of the load can be controlled in conjunction with the supply state of the power source of the vehicle and brightness around the vehicle.

For example, the brightness around the vehicle can be detected by a solar radiation sensor.

The second command part may be connected to an electric power line, through which the electric power is supplied when the vehicle is in the predetermined supply state of the power source, and the second command part may issue the second command by outputting the electric power from the electric power line to the electric-power supply controller.

Therefore, the configuration of the second command part can be simplified.

The second command part may include a switching element that switches between a first direction in which a flow of the electric power from the electric power line is outputted to the electric-power supply controller and a second direction in which the flow of the electric power is not outputted to the electric-power supply controller.

Therefore, the existence or non-existence of the second command can be switched using the switching element.

The operating signal may be a pulsing signal, the second command part may include an integrating circuit that includes a capacitor, and the switching element may be set to a state, in which the electric power from the electric power line passes in the second direction, when a charge amount accumulated in the capacitor by the input of the operating signal is greater than or equal to a predetermined threshold.

Therefore, the malfunction caused by the noise can be prevented.

The first command part may issue the first command based on the predetermined supply state of the power source of the vehicle when a failure of communication with the manipulation part is detected.

Therefore, the vehicle load can surely be actuated even if the communication failure is generated between the manipulation part and the first command part.

The predetermined supply state of the power source of the vehicle may be a supply state of the power source in an on state of ignition of the vehicle.

Therefore, for example, the load can be started up and stopped in conjunction with the ignition of the vehicle during the generation of the abnormality.

According to the aspect of the invention, the load of the vehicle can surely be operated even if the abnormality is generated in the control circuit, such as the CPU, which drives the load.

### BRIEF DESCRIPTION OF THE DRAWINGS

FIG. 1 is a circuit diagram illustrating a configuration example of a conventional in-vehicle system;

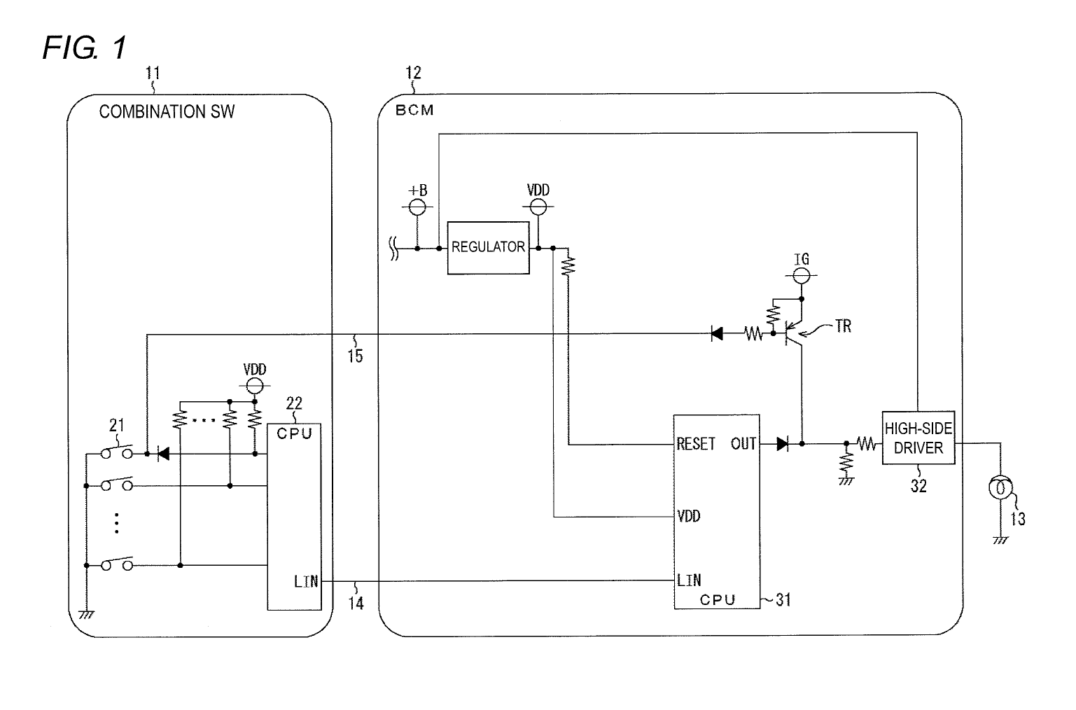

FIG. 2 is a diagram illustrating an operation of the conventional in-vehicle system in generating a communication failure;

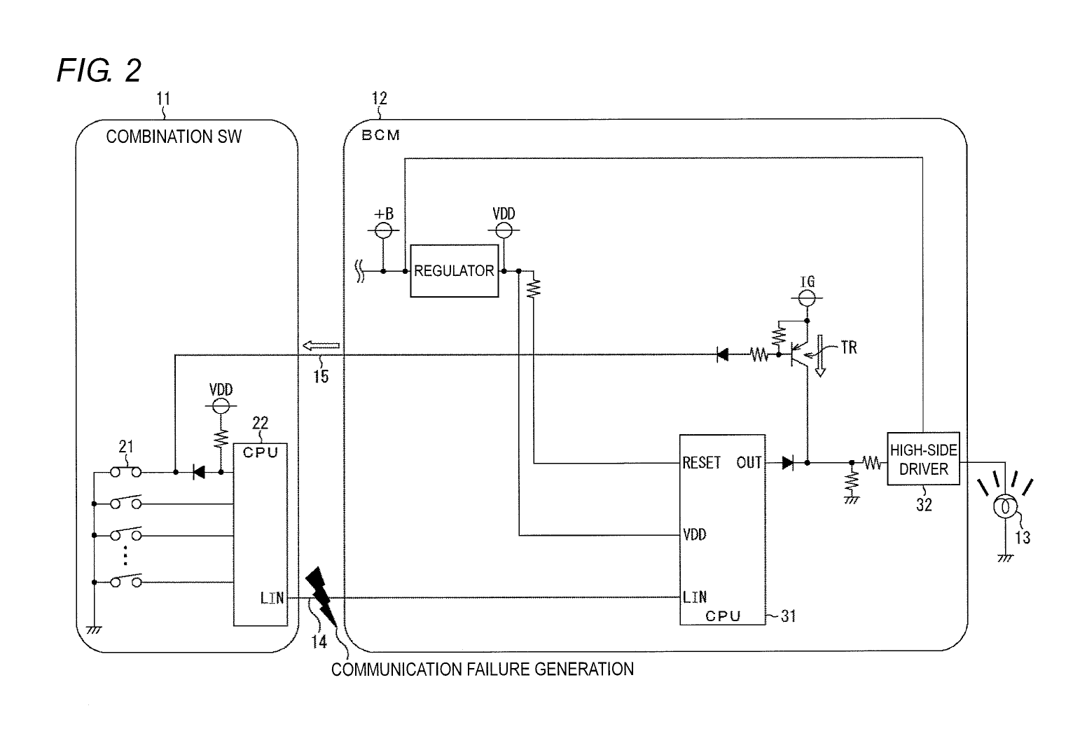

FIG. 3 is a block diagram illustrating a basic configuration example of an in-vehicle system according to the present invention;

FIG. 4 is a circuit diagram illustrating a first specific configuration example of the in-vehicle system according to the present invention;

FIG. 5 is a diagram illustrating a normal operation of the in-vehicle system according to the present invention;

FIG. 6 is a graph illustrating a change in voltage of each part of a BCM.

FIG. 7 is a diagram illustrating an operation of the in-vehicle system according to the present invention during the generation of the communication failure;

FIG. 8 is a diagram illustrating an operation of the in-vehicle system according to the present invention during generation of an abnormality of a CPU; and

FIG. 9 is a circuit diagram illustrating a second specific configuration example of the in-vehicle system according to the present invention.

### DETAILED DESCRIPTION

Hereinafter, preferred embodiments of the present invention will be described. A description is made in the following order.

1. Embodiment

2. Modifications

### 1. Embodiment

### [Basic Configuration Example of In-Vehicle System]

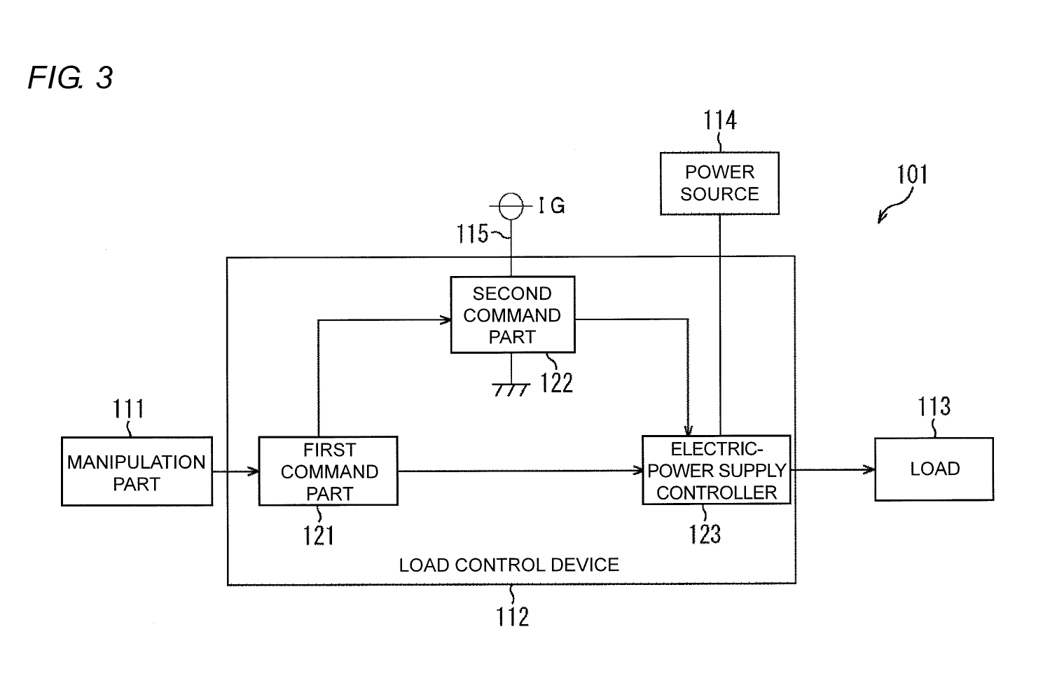

FIG. 3 is a block diagram illustrating a basic configuration example of an in-vehicle system according to the present invention.

Referring to FIG. 3, an in-vehicle system 101 includes a manipulation part 111, a load control device 112, a load 113, and a power source 114. The load control device 112 includes a first command part 121, a second command part 122, and an electric-power supply controller 123.

The in-vehicle system 101 is a system, which is provided in various vehicles and controls the supply of an electric power to the load 113 according to a user manipulation of the manipulation part 111. There is no particular limitation to a kind of a vehicle in which the in-vehicle system 101 is provided. For example, it is conceivable that the in-vehicle system 101 is provided in a vehicle that is driven by an engine, an EV (Electric Vehicle), an HEV (Hybrid Electric Vehicle), and a PHEV (Plug-in Hybrid Electric Vehicle).

The manipulation part 111 includes various manipulation means (such as a switch, a button, and a key). For example, a user manipulates the manipulation part 111 to start up or stop the load 113. The manipulation part 111 outputs a manipulation signal indicating a manipulation content or a state of the manipulation part 111 (for example, an on/off state) to the first command part 121.

For example, the first command part 121 includes various control circuits, such as a CPU (Central Processing Unit) and an ECU (Electronic Control Unit). Based on a manipulation signal from the manipulation part 111, the first command part 121 issues a command to the electric-power supply controller 123 to supply the electric power to the load 113. When detecting a failure of communication with the manipulation part 111, the first command part 121 issues the command to the electric-power supply controller 123 to supply the electric power to the load 113 based on a power source state of the vehicle. When operating normally, the first command part 121 outputs a predetermined operating signal indicating the normal operation to the second command part 122.

For example, the second command part 122 includes electric circuits, such as a drive integrating circuit, the second command part 122 is connected to an electric power line 115 through which the electric power is supplied from an ignition power source IG. When the operating signal is not inputted from the first command part 121, the second command part 122 outputs the electric power from the ignition power source IG to the electric-power supply controller 123, thereby issuing the command to the electric-power supply controller 123 to supply the electric power to the load 113.

The ignition power source IG is a power source for a drive system of the vehicle, and the ignition power source IG supplies the electric power when an ignition switch or a power switch of the vehicle is set to a position in which the vehicle is put into a movable state or a position (for example, an ignition or the on state) in which the user drives the vehicle.

Hereinafter, a name of the switch that switches the on and off states of the ignition power source IG is unified by an ignition switch, and a name of the position of the ignition switch in which the ignition power source IG is turned on is unified by ignition. Hereinafter, sometimes setting the position of the ignition switch to the ignition is referred to as turn-on of the ignition.

For example, the electric-power supply controller 123 includes a driver circuit that controls the supply of the electric power to the load 113. Based on the command from the first command part 121 or the second command part 122, the electric-power supply controller 123 controls the supply of the electric power from the power source 114 to the load 113, thereby controlling start-up and stop of the load 113.

For example, the load 113 includes various in-vehicle electric components that can be started up and stopped by manipulating the manipulation part 111. For example, the load 113 includes electric components, such as a headlight, a taillight, and a windshield wiper motor, which are necessary to drive the vehicle safely.

For example, the power source 114 includes a battery provided in the vehicle.

### [First Specific Configuration Example of In-Vehicle System]

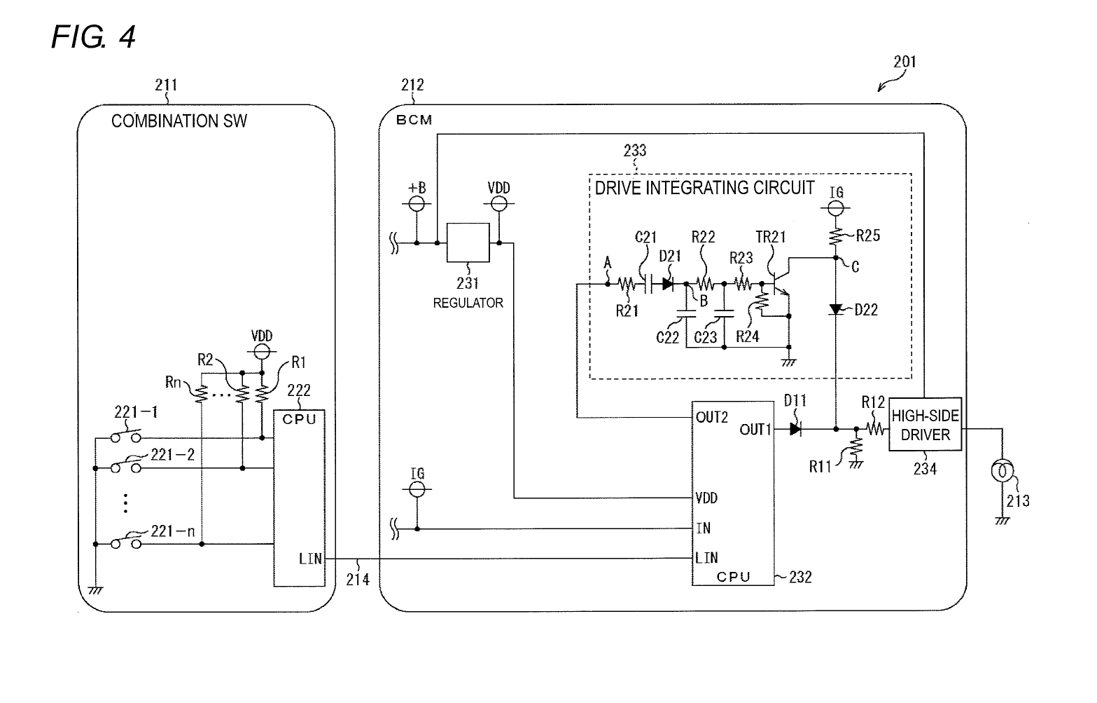

FIG. 4 is a circuit diagram illustrating a first configuration example of an in-vehicle system in which the in-vehicle system 101 in FIG. 3 is objectified.

The in-vehicle system 201 includes a combination SW (switch) 211, a BCM (Body Control Module) 212, and a headlight 213.

The combination SW 211 corresponds to the manipulation part 111 in FIG. 3. The combination SW 211 includes switches 221-1 to 221-n, a CPU 222, and a resistor R1.

The switches 221-1 to 221-n switch operations and states of various loads of the vehicle in which the in-vehicle system 101 is provided. The switch 221-1 switches between the on and off states of the headlight 213. Hereinafter, the switch 221-1 is referred to as a headlight SW (switch).

One end of each of the switches 221-1 to 221-n is connected to the CPU 222, and the other end is connected to a ground. A power source VDD that supplies the electric power of a predetermined DC voltage (for example, 5 V) is connected to between the switch 221-1 and the CPU 222.

The connection position of the power source VDD is not limited to the example in FIG. 4. For example, the power source VDD is connected to another position in which the electric power can be supplied to the CPU 222 irrespective of the states of the switches 221-1 to 221-n.

A line terminal (LIN) of the CPU 222 is connected to a line terminal (LIN) of a CPU 232 of the BCM 212 through a communication line 214, and the CPU 222 and the CPU 232 communicate with each other through the communication line 214. For example, the CPU 222 detects the states of the switches 221-1 to 221-n, and outputs a signal (hereinafter, referred to as a switch state signal) notifying the CPU 232 of the detected state to the CPU 232 through the communication line 214.

The BCM 212 includes a regulator 231, the CPU 232, a drive integrating circuit 233, a high-side driver 234, a diode D11, and resistors R11 and R12. The CPU 232 corresponds to the first command part 121 in FIG. 3, the drive integrating circuit 233 corresponds to the second command part 122 in FIG. 3, and the high-side driver 234 corresponds to the electric-power supply controller 123 in FIG. 3.

An input terminal of the regulator 231 is connected to a battery power source+B that supplies an electric power of a predetermined DC voltage (for example, 12 V) from the battery (not illustrated). An output terminal of the regulator 231 is connected to the power source VDD and a power source terminal (VDD) of the CPU 232. The regulator 231 converts a voltage of the electric power supplied from the battery power source+B into a predetermined voltage (for example, +5 V) and supplies the voltage to the CPU 232.

An input terminal (IN) of the CPU 232 is connected to the ignition power source IG. The CPU 232 detects the on and off states of the ignition power source IG based on the input voltage of the input terminal. The CPU 232 can detect whether the ignition switch is to set to the ignition based on a detection result of the on and off states of the ignition power source IG.

An output terminal 1 (OUT1) of the CPU 232 is connected to an anode of the diode D11. As will be described later, based on the state of the switch 221-1 (headlight SW), the CPU 232 outputs a lighting command signal from the output terminal 1 in order to light the headlight 213. The lighting command signal outputted from the CPU 232 is inputted to the high-side driver 234 through the diode D11 and the resistor R12.

For example, the lighting command signal is a signal of a positive logic (high active).

An output terminal 2 (OUT2) of the CPU 232 is connected to one end of the resistor R21 of the drive integrating circuit 233. When operating normally, the CPU 232 outputs a pulsing operating signal indicating the normal operation from the output terminal 2, and the operating signal is inputted to the drive integrating circuit 233.

One end of the resistor R11 is connected to a cathode of the diode D11, and the other end is connected to the ground. One end of the resistor R12 is connected to the cathode of the diode D11, and the other end is connected to the high-side driver 234.

The drive integrating circuit 233 includes resistors R21 to R24, capacitors C21 to C23, diodes D21 and D22, and an NPN-type transistor TR21.

One end of the resistor R21, which is different from the end connected to the output terminal 2 of the CPU 232, is connected to one end of the capacitor C21. One end of the capacitor C21, which is different from the end connected to one end of resistor R21, is connected to the anode of the diode D21. The cathode of the diode D21 is connected to one end of the capacitor C22 and one end of the resistor R22. One end of the capacitor C22, which is different from the end connected to the cathode of the diode D21, is connected to the ground.

One end of the resistor R22, which is different from the end connected to the cathode of the diode D21, is connected to one end of the capacitor C23 and one end of the resistor R23. One end of the capacitor C23, which is different from the end connected to one end of resistor R22, is connected to the ground.

One end of the resistor R23, which is different from the end connected to one end of the resistor R22, is connected to a base of the transistor TR21. The resistor R24 is connected to between the base and an emitter of the transistor TR21. A collector of the transistor TR21 is connected to the anode of the diode D22, and the emitter is connected to the ground.

A circuit from the resistor R21 to the transistor TR21 constitutes an integrating circuit.

One end of the resistor R25 is connected to the ignition power source IG, and the other end is connected to the anode of the diode D22. The cathode of the diode D22 is connected to the cathode of the diode D11.

As will be described later, the transistor TR21 of the drive integrating circuit 233 is turned off when the operating signal is not inputted from the CPU 232, and the transistor TR21 is turned on when the operating signal is inputted, whereby a flow of the electric power from the ignition power source IG switches between a direction in which the electric power is outputted to the high-side driver 234 and a direction in which the electric power is not outputted to the high-side driver 234.

When the transistor TR21 is in the off state while the ignition power source IG is in the on state, the electric power is inputted from the ignition power source IG to the high-side driver 234 through the diode D22 and the resistor R12 to set the input voltage of the high-side driver 234 to a high level.

Hereinafter, the signal of the positive logic (high active), which is outputted from the drive integrating circuit 233 to the high-side driver 234 using the electric power from the ignition power source IG, is referred to as an abnormal state lighting command signal.

Based on the lighting command signal inputted from the CPU 232 or the abnormal state lighting command signal inputted from the drive integrating circuit 233, the high-side driver 234 controls the lighting and turn-off of the headlight 213 by controlling the electric power supplied from the battery power source+B to the headlight 213.

In the drawings, one end of the resistor R21 on the side of output terminal 2 (the input side of the drive integrating circuit 233) of the CPU 232 is referred to as an A point. In the drawings, a connection point among the cathode of the diode D21, the capacitor C22, and the resistor R22 is referred to as a B point. In the drawings, a connection point among the collector of the transistor TR21, the resistor R25, and the anode of the diode D22 is referred to as a C point.

[Operation of In-Vehicle System 201 in Lighting Headlight 213]

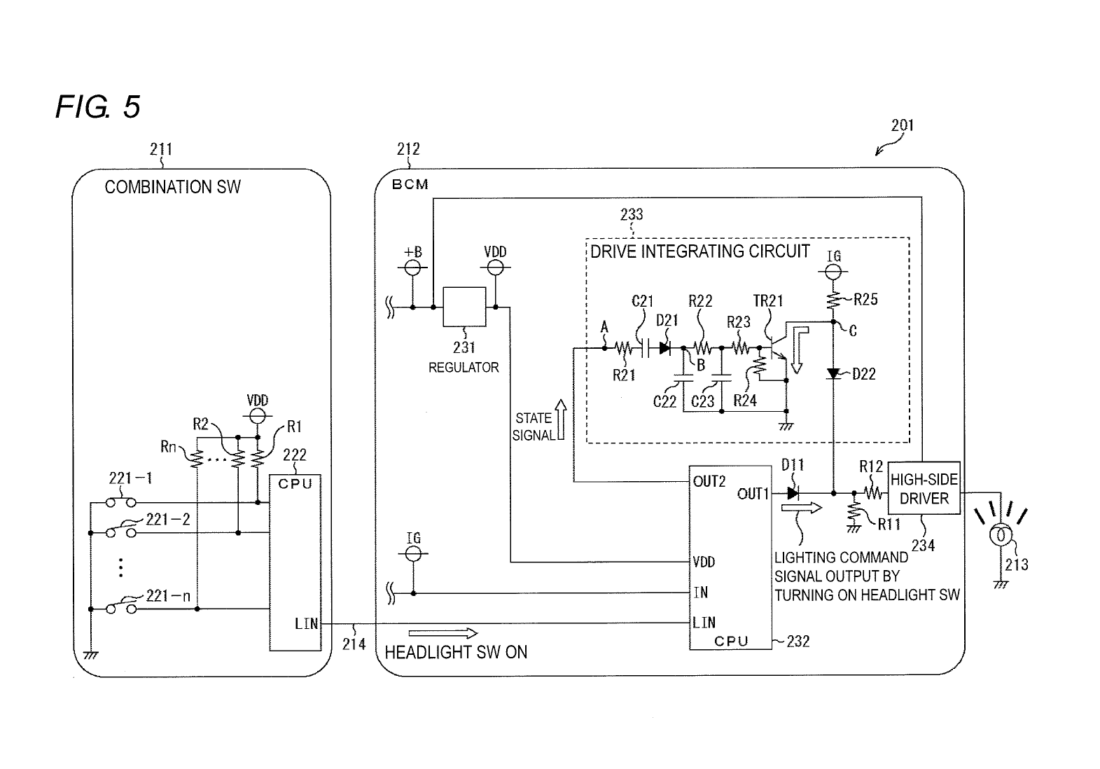

An operation of the in-vehicle system 201 in lighting the headlight 213 will be described with reference to FIGS. 5 to 8.

It is assumed that the transistor TR21 of the drive integrating circuit 233 is turned off before the headlight 213 is lit.

(Normal Operation of In-Vehicle System 201)

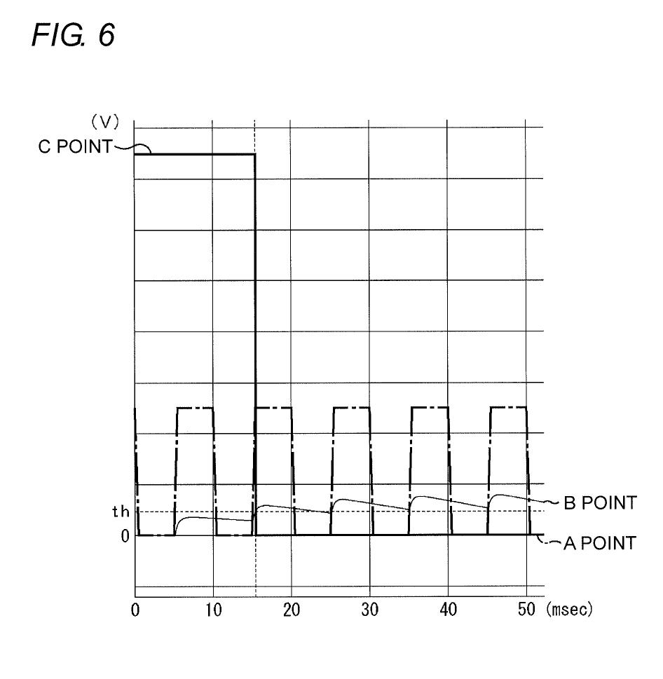

A normal operation to light the headlight 213 in the case that the abnormality is not generated in the in-vehicle system 201 will be described with reference to FIGS. 5 and 6.

When the headlight SW is turned on in order to light the headlight 213, the switch state signal indicating that the headlight SW is turned on is outputted from the line terminal of the CPU 222. The switch state signal outputted from the CPU 222 is inputted to the line terminal of the CPU 232 through the communication line 214.

When detecting the turn-on of the headlight SW based on the switch state signal, the CPU 232 outputs the lighting command signal from the output terminal 1 (the lighting command signal is set to the high level) until the headlight SW is turned off. The lighting command signal outputted from the CPU 232 is inputted to the high-side driver 234 through the diode D11 and the resistor R12.

The high-side driver 234 supplies the electric power from the battery power source+B to the headlight 213 while the lighting command signal is inputted from the CPU 232. Therefore, the headlight 213 is lit.

In the normal operation, the CPU 232 outputs the pulsing state signal from the output terminal 2 to input the state signal to the drive integrating circuit 233.

FIG. 6 is a graph illustrating an example of a change in voltage from the A point to the C point in FIG. 5 immediately after the CPU 232 starts the output of the state signal. A waveform of the voltage at the A point is identical to a waveform of the state signal.

The pulsing state signal inputted to the drive integrating circuit 233 is inputted to the capacitor C21 through the resistor R21. Therefore, the current is passed in the direction from the capacitor C21 toward the diode D21 to accumulate a charge in the capacitor C22. Every time the pulse of the state signal is inputted to the drive integrating circuit 233, an accumulated charge amount of the capacitor C22 increases to raise the potential at the B point as illustrated in FIG. 6.

The predetermined number (for example, two) of state signal pulses are inputted to the drive integrating circuit 233, and the accumulated charge amount of the capacitor C22 is greater than or equal to a predetermined threshold, and the potential at the B point is greater than or equal to a predetermined threshold th. At this point, the transistor TR21 is turned on.

When the transistor TR21 is turned on, the electric power from the ignition power source IG passes through a route including the resistor R25, the transistor TR21, and the ground, but the electric power is not outputted from the drive integrating circuit 233. As illustrated in FIG. 6, the potential at the C point is substantially equal to the ground. Accordingly, the abnormal state lighting command signal is not outputted from the drive integrating circuit 233.

(Operation of In-Vehicle System 201 in Communication Failure)

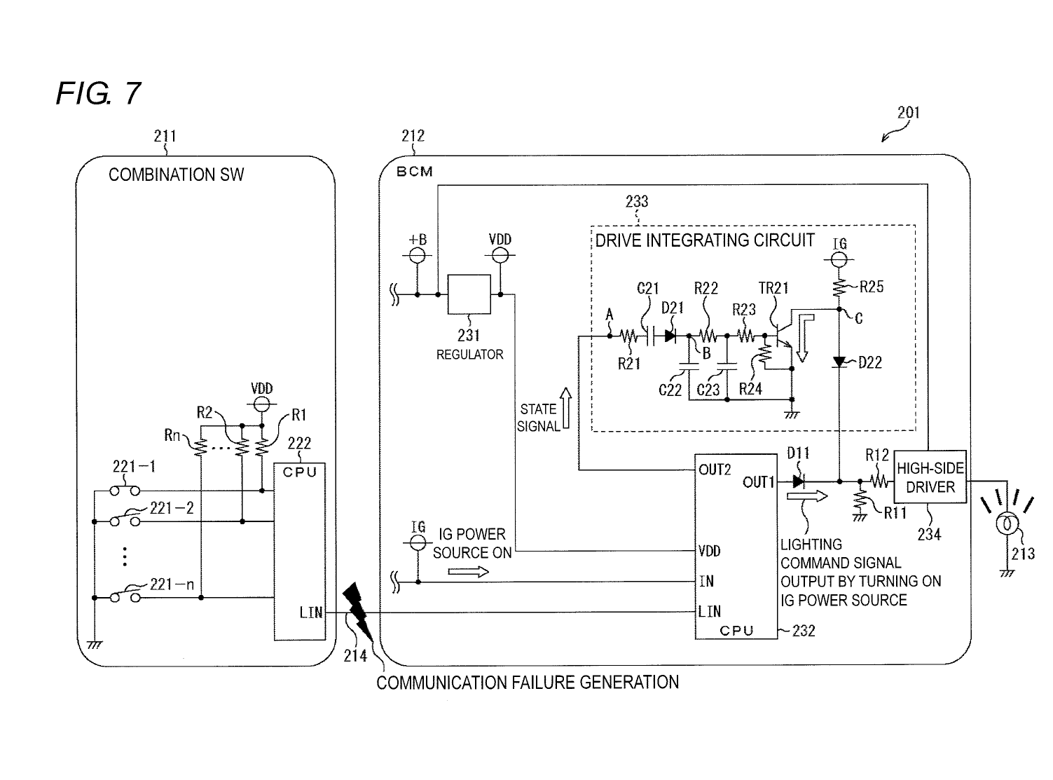

With reference to FIG. 7, a description will now be given of an operation to light the headlight 213 in the case that a communication failure is generated between the combination SW 211 and the BCM 212 in the in-vehicle system 201 due to a disconnection, a power-source short circuit, and a ground fault of the communication line 214 and the abnormality of the combination SW 211 Fig. It is assumed that the BCM 212 operates normally.

In this case, the CPU 232 cannot detect the state of the headlight SW because the CPU 232 cannot receive the switch state signal from the CPU 222 of the combination SW 211 due to the communication failure. On the other hand, the CPU 232 can detect the generation of the communication failure because all the signals inputted from the CPU 222 are stopped due to the communication failure.

Therefore, when detecting the communication failure, the CPU 232 controls the output of the lighting command signal based on the state of the ignition power source IG.

Specifically, the CPU 232 detects whether the ignition power source IG is turned on based on the input voltage of the input terminal. The CPU 232 outputs the lighting command signal from the output terminal 1 (the lighting command signal is set to the high level) while the on state of the ignition power source IG is detected. Therefore, the headlight 213 is lit. On the other hand, the CPU 232 stops the output of the lighting command signal (the lighting command signal is set to the low level) while the off state of the ignition power source IG is detected. Therefore, the headlight 213 is turned off.

In the case that the communication failure is generated, the lighting and the turn-off of the headlight 213 are controlled in conjunction with the ignition power source IG. That is, even if the CPU 232 cannot detect the state of the headlight SW due to the communication failure, the vehicle is set to a predetermined supply state of the power source, namely, the ignition is turned on to turn on the ignition power source IG, which allows the headlight 213 to be lit. Accordingly, the headlight 213 can be lit during the running of the vehicle to ensure the safe driving. On the other hand, the ignition switch of the vehicle is set to an accessory or the off state to turn off the ignition power source IG, which allows the headlight 213 to be turned off.

In this case, similarly to the normal operation, the CPU 232 operates normally, the state signal is inputted from the CPU 232 to the drive integrating circuit 233, and the transistor TR21 is in the on state. Therefore, the drive integrating circuit 233 does not output the abnormal state lighting command signal.

(Operation of In-Vehicle System 201 when Abnormality is Generated in CPU 232)

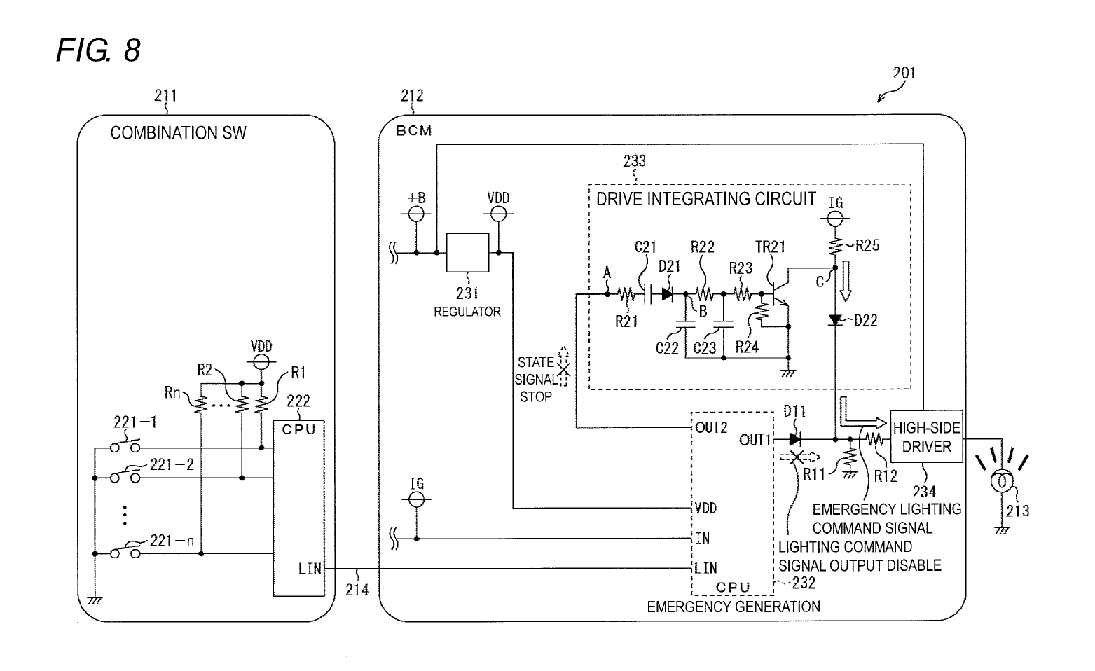

With reference to FIG. 8, a description will now be given of an operation to light the headlight 213 in the case that the abnormality, such as a runaway and a sudden stop of the CPU 232 of the BCM 212, is generated in the in-vehicle system 201 Fig. In this case, the same operation is performed irrespective of the existence or non-existence of the generation of the communication failure between the combination SW 211 and the BCM 212.

The headlight 213 cannot be lit by the command from the CPU 232 because the CPU 232 does not output the lighting command signal irrespective of the state of the headlight SW and the state of the ignition power source IG.

Due to the abnormality of the CPU 232, the CPU 232 does not output the state signal. As a result, the accumulated charge amount of the capacitor C22 of the drive integrating circuit 233 decreases and becomes less than a predetermined threshold, and the transistor TR21 is turned off when the voltage at the B point becomes less that the threshold th.

When the transistor TR21 becomes the off state while the ignition power source IG is in the on state, the electric power is inputted from the ignition power source IG to the high-side driver 234 through the diode D22 and the resistor R12. That is, the abnormal state lighting command signal is inputted to the high-side driver 234 (the abnormal state lighting command signal is set to the high level).

The high-side driver 234 supplies the electric power from the battery power source+B to the headlight 213 while the abnormal state lighting command signal is inputted from the drive integrating circuit 233. Therefore, the headlight 213 is lit.

Then, the CPU 232 returns to the normal state to resume the output of the state signal, and the predetermined number (for example, two) of state signal pulses are inputted to the drive integrating circuit 233, thereby turning on the transistor TR21. As a result, the drive integrating circuit 233 stops the output of the abnormal state lighting command signal.

Accordingly, until the CPU 232 returns to the normal state since the abnormality is generated in the CPU 232, the headlight 213 can be lit by setting the vehicle to the predetermined supply state of the power source, namely by turning on the ignition to turn on the ignition power source IG. The headlight 213 can be turned off by turning off the ignition power source IG.

As described above, in the in-vehicle system 201, the headlight 213 can surely be lit even if the communication failure is generated between the combination SW 211 and the BCM 212 or even if the abnormality is generated in the CPU 232.

A malfunction caused by a noise can be prevented because the output of the abnormal state lighting command signal is stopped after the predetermined number of state signal pulses are inputted.

[Second Specific Configuration Example of In-Vehicle System]

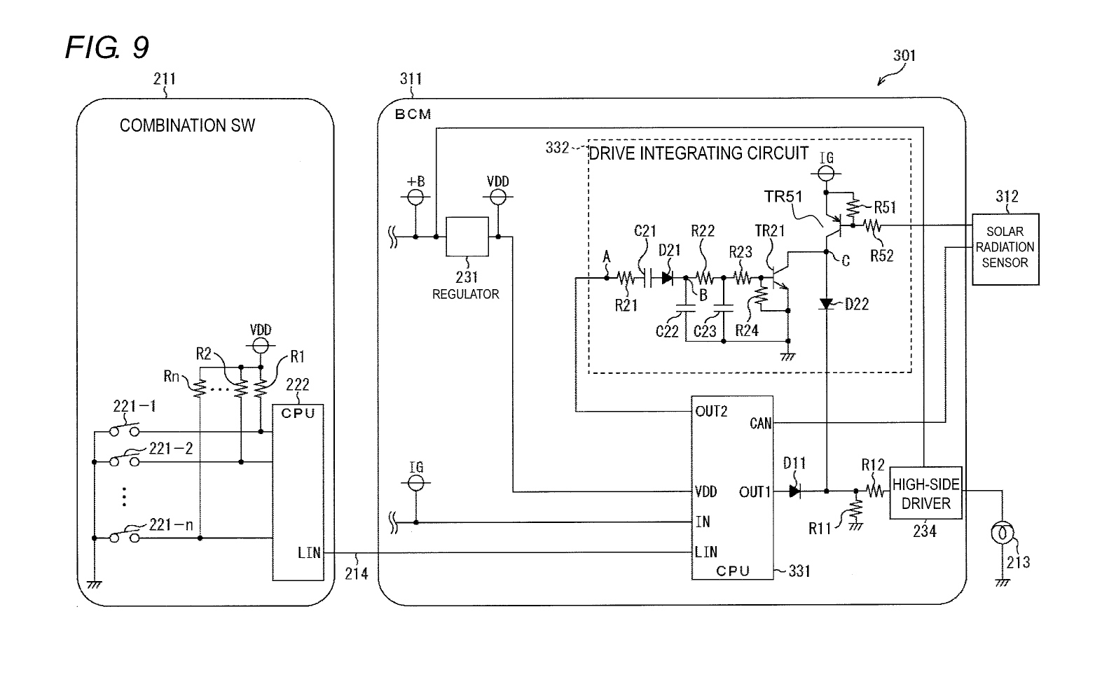

FIG. 9 is a circuit diagram illustrating a second configuration example of the in-vehicle system in which the in-vehicle system 101 in FIG. 3 is objectified.

In FIG. 9, the component corresponding to that in FIG. 4 is designated by the same numeral, and the repetitive description of the same processing is omitted as appropriate.

An in-vehicle system 301 in FIG. 9 differs from the in-vehicle system 201 in FIG. 4 in that a BCM 311 is provided instead of the BCM 212 and that a solar radiation sensor 312 is added. The BCM 311 differs from the BCM 212 in that a CPU 331 and a drive integrating circuit 332 are provided instead of the CPU 232 and the drive integrating circuit 233.

The CPU 331 differs from the CPU 232 in FIG. 4 in that the solar radiation sensor 312 is connected to a CAN terminal.

The drive integrating circuit 332 differs from the drive integrating circuit 233 in FIG. 4 in that resistors R51 and R52 and a transistor TR51 are added while the resistor R25 is eliminated.

The resistor R51 is connected between the base and the emitter of the transistor TR51. One end of the resistor R52 is connected to the base of the transistor TR51, and the other end is connected to the solar radiation sensor 312. The emitter of the transistor TR51 is connected to the ignition power source IG, and the collector is connected to the anode of the diode D22.

The solar radiation sensor 312 detects light and dark around the vehicle. When detecting that the brightness around the vehicle is greater than or equal to a predetermined threshold or that the brightness is less than the predetermined threshold, the solar radiation sensor 312 notifies the CPU 331 of such by CAN communication.

A signal outputted from the solar radiation sensor 312 from drive integrating circuit 332 becomes high when the brightness around the vehicle is greater than or equal to the predetermined threshold, and the signal becomes low when the brightness is less than the predetermined threshold. Accordingly, the transistor TR51 of the drive integrating circuit 332 is turned off when the output signal of the solar radiation sensor 312 is high, namely, when the brightness around the vehicle is greater than of equal to the predetermined threshold, and the transistor TR51 is turned on when the output signal of the solar radiation sensor 312 is low, namely, when the brightness around the vehicle is less than the predetermined threshold.

[Operation of In-Vehicle System 301 in Lighting Headlight 213]

An operation of the in-vehicle system 301 in lighting the headlight 213 will be described below.

(Normal Operation of In-Vehicle System 301)

The normal operation to light the headlight 213 in the case that the abnormality is not generated in the in-vehicle system 301 will be described.

In the case that the in-vehicle system 301 operates normally, in addition to the turn-on of the headlight SW, the headlight 213 is lit when the surroundings of the vehicle becomes dark while the switch 221-2 (hereinafter, referred to as an auto light SW) is turned on.

Specifically, in the case that the auto light SW is turned on, the CPU 331 outputs the lighting command signal from the output terminal 1 (the lighting command signal is set to the high level) when the solar radiation sensor 312 notifies the CPU 331 that the brightness around the vehicle is less than the predetermined threshold. Therefore, the headlight 213 is lit.

On the other hand, in the case that the auto light SW is turned on, the CPU 331 stops the output of the lighting command signal from the output terminal 1 when the solar radiation sensor 312 notifies the CPU 331 that the brightness around the vehicle is greater than or equal to the predetermined threshold. Therefore, the headlight 213 is turned off.

Accordingly, in the case that the headlight SW is turned on, the headlight 213 is automatically lit or turned off in conjunction with the brightness around the vehicle.

In this case, the CPU 331 operates normally, and the state signal is inputted from the CPU 331 to the drive integrating circuit 332, and the transistor TR21 is in the on state. Therefore, irrespective of the state of the transistor TR51, the drive integrating circuit 332 does not output the abnormal state lighting command signal.

(Operation of In-Vehicle System 301 in Communication Failure)

A description will now be given of an operation to light the headlight 213 in the case that the communication failure is generated between the combination SW 211 and the BCM 311 in the in-vehicle system 301 due to the disconnection, the power-source short circuit, and the ground fault of the communication line 214 and the abnormality of the combination SW 211. It is assumed that the BCM 311 operates normally.

The CPU 331 detects whether the ignition power source IG is turned on based on the input voltage of the input terminal. While the on state of the ignition power source IG is detected, the CPU 331 outputs the lighting command signal from the output terminal 1 (the lighting command signal is set to the high level) until the solar radiation sensor 312 notifies the CPU 331 that the brightness around the vehicle is greater than or equal to the predetermined threshold since the brightness around the vehicle is less than the predetermined threshold. Therefore, the headlight 213 is lit. On the other hand, the CPU 331 stops the output of the lighting command signal (the lighting command signal is set to the low level) while the off state of the ignition power source IG is detected. Therefore, the headlight 213 is turned off.

Accordingly, in the case that the communication failure is generated, the lighting and the turn-off of the headlight 213 are controlled in conjunction with the ignition power source IG and the brightness around the vehicle.

In this case, similarly to the normal operation, the CPU 331 operates normally, and the state signal is inputted from the CPU 331 to the drive integrating circuit 332, and the transistor TR21 is in the on state. Therefore, irrespective of the state of the transistor TR51, the drive integrating circuit 332 does not output the abnormal state lighting command signal.

(Operation of In-Vehicle System 301 when Abnormality is Generated in CPU 331)

A description will now be given of an operation to light the headlight 213 in the case that the abnormality, such as the runaway and the sudden stop of the CPU 331 of the BCM 311, is generated in the in-vehicle system 301. In this case, the same operation is performed irrespective of the existence or non-existence of the generation of the communication failure between the combination SW 211 and the BCM 311.

In this case, the headlight 213 cannot be lit by the command from the CPU 331 because the CPU 331 does not output the lighting command signal irrespective of the state of the headlight SW, the state of the auto light SW, and the state of the ignition power source IG.

Due to the abnormality of the CPU 331, the CPU 331 does not output the state signal. As a result, the accumulated charge amount of the capacitor C22 of the drive integrating circuit 332 decreases and becomes less than a predetermined threshold, and the transistor TR21 is turned off when the voltage at the B point becomes less that the threshold th.

On the other hand, as described above, the transistor TR51 is turned off while the output signal of the solar radiation sensor 312 is high, and the transistor TR51 is turned on while the output signal of the solar radiation sensor 312 is low.

Accordingly, when the transistor TR21 is in the off state, and when the transistor TR51 becomes the on state while the ignition power source IG is in the on state, the electric power is inputted from the ignition power source IG to the high-side driver 234 through the diode D22 and the resistor R12. That is, the abnormal state lighting command signal is inputted to the high-side driver 234 (the abnormal state lighting command signal is set to the high level). Therefore, the headlight 213 is lit.

Then, the CPU 331 returns to the normal state to resume the output of the state signal, and the predetermined number (for example, two) of state signal pulses are inputted to the drive integrating circuit 332, thereby turning on the transistor TR21. As a result, the drive integrating circuit 332 stops the output of the abnormal state lighting command signal.

Accordingly, the lighting and the turn-off of the headlight 213 are controlled in conjunction with the ignition power source IG and the brightness around the vehicle until the CPU 331 returns to the normal state since the abnormality is generated in the CPU 331.

As described above, in the in-vehicle system 301, the headlight 213 can surely be lit even if the communication failure is generated between the combination SW 211 and the BCM 311 or even if the abnormality is generated in the CPU 331.

### 2. Modifications

Modifications of the embodiments of the present invention will be described below.

The circuit configuration of the BCM is described above by way of example, and may appropriately be changed.

For example, an FET (Field Effect Transistor) may be used instead of the bipolar transistor. In the foregoing description, the drive integrating circuit 233 and the drive integrating circuit 332 include circuit elements, such as the transistor, by way of example. For example, an IC circuit having the same functions as the circuit elements may be used.

With the change of the circuit configuration, a positive logic and a negative logic of each signal may be reversed, the pulse signal may be changed to a continuous signal, or the continuous signal may be changed to the pulse signal.

In the foregoing description, by way of example, the CPU 222 is provided between the switches 221-1 to 221-n and the BCM 212 or the BCM 311, and the CPU 222 communicates with the BCM 212 or the BCM 311. However, the present invention can be applied to the case that the switch and the BCM 212 or the BCM 311 directly communicate with each other while the switch is directly connected to the BCM 212 or the BCM 311 through the communication line.

An arbitrary communication system (for example, analog communication) except the CAN communication may be adopted in the communication between the solar radiation sensor 312 of the in-vehicle system 301 and the CPU 331.

Another switching part that is switched according to a value of the output signal of the solar radiation sensor 312 may be used instead of the transistor TR51 of the drive integrating circuit 332.

The present invention can also be applied to the case that the electric power is supplied to in-vehicle electric components except the headlight.

In the foregoing description, by way of example, the headlight 213 is lit in conjunction with the ignition power source IG when the communication failure or the abnormality of the CPU is generated. For example, the headlight 213 may be lit in conjunction with another power source (for example, an accessory power source) according to the kind of the load.

The present invention is not limited to the above embodiments, but various changes can be made without departing from the scope of the invention.

1. A load control device that controls a load of a vehicle based on a signal inputted from a manipulation part manipulated by a user, the load control device comprising:
a first command part that issues a first command to supply an electric power to the load based on the signal from the manipulation part, and outputs a predetermined operating signal when operating normally;
a second command part that issues a second command to supply the electric power to the load when the operating signal is not inputted from the first command part; and
an electric-power supply controller that controls the supply of the electric power to the load based on the first command or the second command.

2. The load control device according to claim 1, wherein the second command part issues the second command when the vehicle is in a predetermined supply state of a power source.

3. The load control device according to claim 2, wherein the second command part issues the second command when the vehicle is in the predetermined supply state of the power source, and when brightness around the vehicle is less than a predetermined threshold.

4. The load control device according to claim 2, wherein the second command part is connected to an electric power line, through which the electric power is supplied when the vehicle is in the predetermined supply state of the power source, and the second command part issues the second command by outputting the electric power from the electric power line to the electric-power supply controller.

5. The load control device according to claim 4, wherein the second command part includes a switching element that switches between a first direction in which a flow of the electric power from the electric power line is outputted to the electric-power supply controller and a second direction in which the flow of the electric power is not outputted to the electric-power supply controller.

6. The load control device according to claim 5, wherein the operating signal is a pulsing signal, the second command part includes an integrating circuit that includes a capacitor, and the switching element is set to a state, in which the electric power from the electric power line passes in the second direction, when a charge amount accumulated in the capacitor by the input of the operating signal is greater than or equal to a predetermined threshold.

7. The load control device according to claim 2, wherein the first command part issues the first command based on the predetermined supply state of the power source of the vehicle when a failure of communication with the manipulation part is detected.

8. The load control device according to claim 2, wherein the predetermined supply state of the power source of the vehicle is a supply state of the power source in an on state of ignition of the vehicle.

9. The load control device according to claim 3, wherein the second command part is connected to an electric power line, through which the electric power is supplied when the vehicle is in the predetermined supply state of the power source, and the second command part issues the second command by outputting the electric power from the electric power line to the electric-power supply controller.

10. The load control device according to claim 3, wherein the first command part issues the first command based on the predetermined supply state of the power source of the vehicle when a failure of communication with the manipulation part is detected.

11. The load control device according to claim 4, wherein the first command part issues the first command based on the predetermined supply state of the power source of the vehicle when a failure of communication with the manipulation part is detected.

12. The load control device according to claim 5, wherein the first command part issues the first command based on the predetermined supply state of the power source of the vehicle when a failure of communication with the manipulation part is detected.

13. The load control device according to claim 6, wherein the first command part issues the first command based on the predetermined supply state of the power source of the vehicle when a failure of communication with the manipulation part is detected.

14. The load control device according to claim 3, wherein the predetermined supply state of the power source of the vehicle is a supply state of the power source in an on state of ignition of the vehicle.

15. The load control device according to claim 4, wherein the predetermined supply state of the power source of the vehicle is a supply state of the power source in an on state of ignition of the vehicle.

16. The load control device according to claim 5, wherein the predetermined supply state of the power source of the vehicle is a supply state of the power source in an on state of ignition of the vehicle.

17. The load control device according to claim 6, wherein the predetermined supply state of the power source of the vehicle is a supply state of the power source in an on state of ignition of the vehicle.

18. The load control device according to claim 7, wherein the predetermined supply state of the power source of the vehicle is a supply state of the power source in an on state of ignition of the vehicle.

19. The load control device according to claim 9, wherein the second command part includes a switching element that switches between a first direction in which a flow of the electric power from the electric power line is outputted to the electric-power supply controller and a second direction in which the flow of the electric power is not outputted to the electric-power supply controller.

20. The load control device according to claim 19, wherein the operating signal is a pulsing signal, the second command part includes an integrating circuit that includes a capacitor, and the switching element is set to a state, in which the electric power from the electric power line passes in the second direction, when a charge amount accumulated in the capacitor by the input of the operating signal is greater than or equal to a predetermined threshold.
